(19) United States
(12) Patent Application Publication
(10) Pub. No.: US 2009/0134598 A1
(43) Pub. Date: May 28, 2009

(54) BICYCLE HEADSET ASSEMBLY

(76) Inventors: Michael McKernan, Frisco, CO (US); Eric Kackley, Olympia, WA (US)

Correspondence Address: Oppedahl Patent Law Firm LLC, P.O. BOX 4850, FRISCO, CO, 80443-4850, US

(21) Appl. No.: 11/962,950

(22) Filed: Dec. 21, 2007

Related U.S. Application Data
(60) Provisional application No. 60/990,252, filed on Nov. 26, 2007.

(51) Int. Cl. B62K 21/00; B23P 11/00

(52) U.S. Cl. 280/279; 29/428

(57) ABSTRACT

The following method involves a bicycle steering assembly on a steerer member attached to the bicycle's front fork. A threaded top portion of a headset bottom cup is inserted into a threaded bottom end of a head tube and the headset bottom cup is rotated until a bottom portion of the headset bottom cup abuts against the head tube. A threaded bottom portion of a headset top cup is inserted into a threaded top end of the head tube and the headset top cup is rotated until a top portion of the headset top cup abuts against the head tube. A bearing is juxtaposed between the bottom portion of the headset bottom cup and the top portion of the headset bottom cup. A bearing is juxtaposed between the top portion of the headset top cup and the bottom portion of the headset top cup. The steerer member is slid through the following in order: the headset bottom cup, the head tube, and the headset top cup.

### CROSS REFERENCE TO RELATED APPLICATIONS

This application claims priority from and is a non-provisional of U.S. provisional application No. 60/990,252, filed on Nov. 26, 2007, which is incorporated herein by reference for all purposes.

### BACKGROUND OF THE INVENTION

Today's bicycle models range from those that can be found at “big box” discount stores, to those bought “off the rack” at specialty bike shops, on up to special “custom” bicycles that are made for an individual rider with a particular use in mind. There are many different designs of bicycles available, each corresponding to a specific type of use. At the simplest level, there are road bikes for riding on hard smooth surfaces and mountain bikes for riding on dirt paths or other rougher terrain. Depending on the needs of the cyclist, road bikes may be further specialized for activities such as road racing, just like specialized mountain bikes may be designed to take on the tremendous forces related to down-hill racing. The more specialized the bicycle, the more likely the cost associated with it will be higher, both at the time of purchase and when it comes time for maintenance. Maintenance costs involve the cost associated with the person performing the service as well as the cost of replacement parts. It is likely that the more specialized and expensive a particular bicycle is at the time of purchase, the more expensive parts will be and the more specialized knowledge the service person should have.

Individuals who purchase a single bike for several thousands of dollars would likely desire to have it serviced by an expert, that is if the individual weren't planning on doing his/her own maintenance. Regardless of where the service is performed, the bicycle owner would be rather dismayed if, in the process of making one repair or replacing one part, another part were damaged or rendered useless. One particular type of maintenance that may involve substantial risk of damage to a very expensive part of a bicycle is replacement of the bicycle's headset.

The headset of a bicycle is critical to its steering performance. A bicycle headset is described by Sheldon Brown's online bicycle glossary (http://www.sheldonbrown.com/glossary-h.html) as “the bearing assembly that connects the front fork to the frame, and permits the fork to turn for steering and balancing.” The glossary further describes prior-art “conventional threaded headset(s)” as having four races in addition to their associated parts which include: the crown race, the lower head race, the upper head race, the adjustable race which attaches to the steerer tube, and the head tube. In the case of prior-art threaded headsets, the adjustable race is secured by a keyed washer and lock nut. More recently, the bicycle industry commonly uses what are referred to as “threadless” headsets. In most prior-art threadless headsets, the adjustable race is secured by a star fangled nut and cap, or compression rings. Mr. Brown's glossary further distinguishes threaded headsets from threadless headsets by pointing out that “traditional threaded headsets fit forks with threaded steerers” while “threadless headsets have an adjustable race that slips over an un-threaded steerer”.

An exemplary embodiment of a prior-art threadless headset is described in U.S. Pat. No. 5,095,770 (“Rader”). The threadless headset of the Rader patent is illustrated in FIG. 1, FIG. 2, and FIG. 4A. Here the steerer tube (101) is attached to the front fork (105). The steerer tube creates an axis (102) which runs through the head tube (130). The top bearing cup (110) has a bottom portion (111) which is pressed into the top end (131) of the head tube (130). The bottom bearing cup (120) has a top portion (121) which is pressed into the bottom end (132) of the head tube (130).

Replacement of prior-art headsets such as the one described by Rader can cause significant damage to the head tube (130) if not completed correctly. The reason for this is that the bearing cups (110 and 120) are “pressed” into the head tube (130) and are held in place by an interference fit. An interference fit occurs in prior-art steering assemblies when either the top portion (121) of the bottom bearing cup (120) or the bottom portion (111) of the top bearing cup (110) is pressed into the head tube (130). The pressing causes the bearing cups (110 and 120) and the head tube (130) to interfere with each other's occupation of space. The result is that the bearing cups (110 and 120) and the head tube (130) deform slightly due to the compression. The interface between the bearing cups (110 and 120) and the head tube (130) is one of such high friction that even large amounts of torque will not turn one of them relative to the other. Prior to pressing, there must be a slight diameter difference between the bearing cups (110 and 120) and the head tube (130). According to a website provided by Park Tool at http:www.parktool.com/repair/readhowto.asp?id=65, the outside diameter (114) of the bottom portion (111) of the top bearing cup (110) and outside diameter (124) of the top portion (121) of the bottom bearing cup (120) typically should be between 0.1 mm to 0.25 mm larger than the head tube's (130) inside diameter (133a). As described above, the process of pressing the cups (110 and 120) into the head tub (130) will cause the head tube (130) to flex and slightly enlarge in order to receive the cups (110 and 120). If at the time the cups (110 and 120) and head tube (130) are pressed together there is any misalignment, there is a chance that improper deformation or other damage could occur to either the cups (110 and 120) or the head tube (130) rendering the prior working part useless. In the case of a damaged head tube (due to flaring or the head tube becoming ovalized), replacement is usually the only option and replacement costs are extremely high as the replacement part is likely to be an entire new bicycle frame.

Another disadvantage to the pressed headsets of the prior art is that in order to properly replace them, a special tool typically called a “headset press” must be utilized. It is not unusual for this special tool to cost as much as $500. In addition it takes up valuable storage space and presents the risk of being lost or stolen. A typical bicycle owner does not have this expensive tool in their garage so a trip to a bicycle shop is required. Hopefully the bicycle technician on duty has been trained in bearing cup replacement, or as discussed above, the head tube (130), the bicycle frame (150), and the replacement headsets themselves could be at risk.

### SUMMARY OF THE INVENTION

Embodiments of the current invention provide an alternative to the risks associated with prior-art “pressed” headsets. When the current invention is utilized, there is no longer a need for great force in order to insert the bearing cups into the head tube. An expensive headset press is no longer required. It is likely that the headsets of the current invention may even be replaced without having to take a trip to a bicycle repair shop. The risk of a headset being incorrectly replaced and resulting in additional damage is also very unlikely when the embodiments of the current invention are employed.

The current invention is an improvement over the “interference” fit “pressed” headsets of the prior art because instead of the headsets being held in place within the head tube by the friction resulting from the interference fit, the headsets and the head tube of the current invention are threaded, which allows them to simply be screwed together. The threads of the current invention make the prior-art practice of installing headsets by forceful pressing unnecessary.

An exemplary embodiment of the current invention is a bicycle steering assembly characterized in that the bottom portion of the upper bearing cup and the top portion of the bottom bearing cup are each threaded with male threads. The head tube of the steering assembly is threaded with female threads. The bearing cups of this exemplary embodiment of the current invention are held in place within the head tube by the threads. One who practices the invention may either acquire the threaded headsets and head tubes of the invention “ready-made”, or cut threads into standard prior-art headsets and head tubes. It should also be appreciated that one practicing the invention could also manufacture the headsets and head tubes of the invention. The manufacturing process may require cutting threads or possibly even molding the parts with the threads formed during the casting process. Once the threads exist, an extra tool such as the above-mentioned headset press is no longer required to install the bearing cups into the head tube. The headsets of the current invention are simply aligned then screwed in.

A practitioner may be in a situation where a bicycle already has the female-threaded head tube of the current invention, but the only headsets on hand are those of the prior art. In this case, the practitioner would simply thread the prior-art headsets with male threads. Another situation may arise where the practitioner only has the headsets of the current invention, but has a prior-art head tube. In this cases, the practitioner would simply thread the prior-art head tube with female threads.

Another exemplary embodiment of the invention is the following method involving a bicycle steering assembly on a steerer member attached to the bicycles' front fork. A threaded top portion of a headset bottom cup is inserted into a threaded bottom end of a head tube and the headset bottom cup is rotated until a bottom portion of the headset bottom cup abuts against the head tube. A threaded bottom portion of a headset top cup is inserted into a threaded top end of the head tube and the headset top cup is rotated until a top portion of the headset top cup abuts against the head tube. A bearing is juxtaposed between the bottom portion of the headset bottom cup and the top portion of the headset bottom cup. A bearing is juxtaposed between the top portion of the headset top cup and the bottom portion of the headset top cup. The steerer member is slid through the following in order: the headset bottom cup, the head tube, and the headset top cup.

One advantage of this invention is that it will likely not cause significant alterations to the manufacturing process currently used for prior-art headsets and head tubes. It also allows prior-art parts currently in bicycle repair shops and installed on bicycles already in use to have minor modifications allowing them to become or be used with embodiments of the current invention.

### BRIEF DESCRIPTION OF THE DRAWINGS

FIG. 1 is an illustration of a prior-art headset as described in the Rader patent application. Neither the bottom portion (111) of the headset top cup (110) nor the top portion (121) of the headset bottom cup (120) is in threaded relationship with the head tube (130).

FIG. 2 is an illustration of the basic parts of the front portion of a bicycle. This particular figure is meant to illustrate locations of various prior-art parts as well as parts utilized with the current invention.

FIG. 3 shows the steering assembly of the current invention. It illustrates the axis (102) and a view of how the steerer member (101) is positioned on the axis 102 inside the head tube (230) and headset cups (210 and 220).

FIG. 4A is an illustration of a prior-art headset. Neither the bottom portion (111) of the headset top cup (110) nor the top portion (121) of the headset bottom cup (120) is in threaded relationship with the head tube (130).

FIG. 4B is an illustration of the headset of the current invention. The bottom portion (211) of the headset top cup (210) and the top portion (221) of the headset bottom cup (220) is in threaded relationship with the head tube (230).

FIG. 5A is a top view of the head tube (230) in threaded relationship with the top cup tube (213) of the bottom portion (211) of the headset top cup (210). It also shows the steerer member (101) positioned inside the top cup tube (213).

FIG. 5B is a bottom view of the head tube (230) in threaded relationship with the bottom cup tube (223) of the top portion (221) of the headset bottom cup (220). It also shows the steerer member (101) positioned inside the bottom cup tube (223).

FIG. 6 is an illustration showing the internal/female threads (238 and 239) of the head tube (230).

FIG. 7 is an illustration showing the headset top cup male threads (218) and the headset bottom cup male threads (219).

Where possible, throughout the figures, like elements have been designated with like reference numerals.

### DETAILED DESCRIPTION

### Bicycle Terminology

The following is a list and corresponding definitions of basic bicycle terminology used in the following detailed description of the invention.
Bicycle fork: The fork (105) is the portion of a bicycle that holds the front wheel (106) and allows the rider to steer and balance the bicycle.
Steerer member: The steerer member (101) is often referred to in the industry as a steerer tube or steering tube; this is the portion of the bicycle fork (105) to which the handlebars attach (via a stem (107)) allowing the user to steer the bicycle. The steerer member (101) interfaces with the frame (150) via a set of bearings known as a headset. Although it often is the case, it is not necessary with respect to the current invention that the steerer member (101) be hollow. It could instead be completely or partially solid.
Headset: The headset (170) is the set of components on a bicycle which provide a rotatable interface between the bicycle fork (105) and the bicycle frame (150) itself.
Bicycle headset bearings: Bearings (115, 125, 215, and 225) capable of being utilized by the headsets of the current invention include but are not limited to ball bearings (loose balls, caged balls, or those presealed in a cartridge). Other appropriate types of bearings such as needle bearings or roller bearings may also be utilized.

### EXEMPLARY EMBODIMENTS

The following are several embodiments of the current invention.

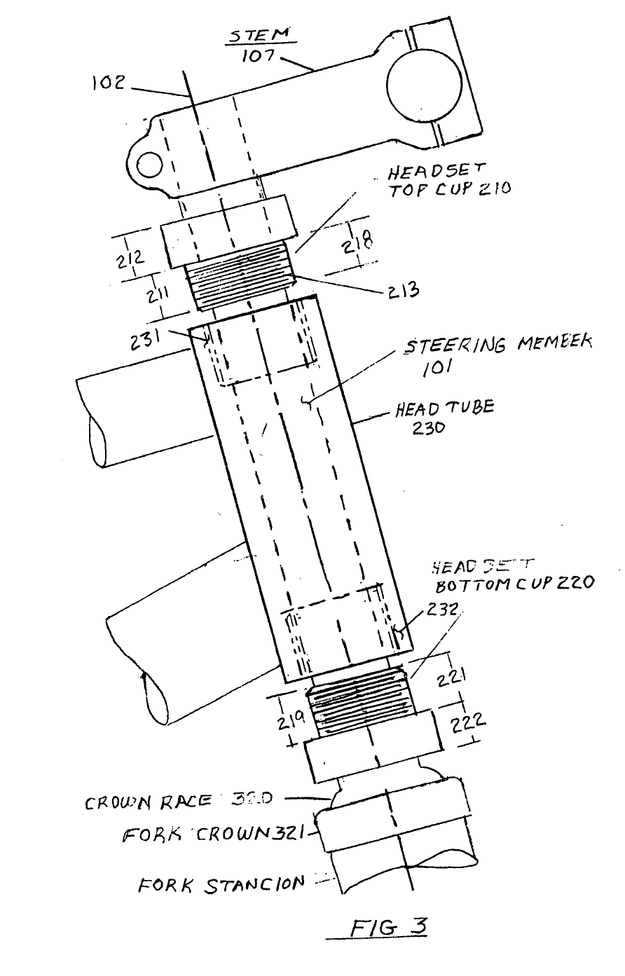

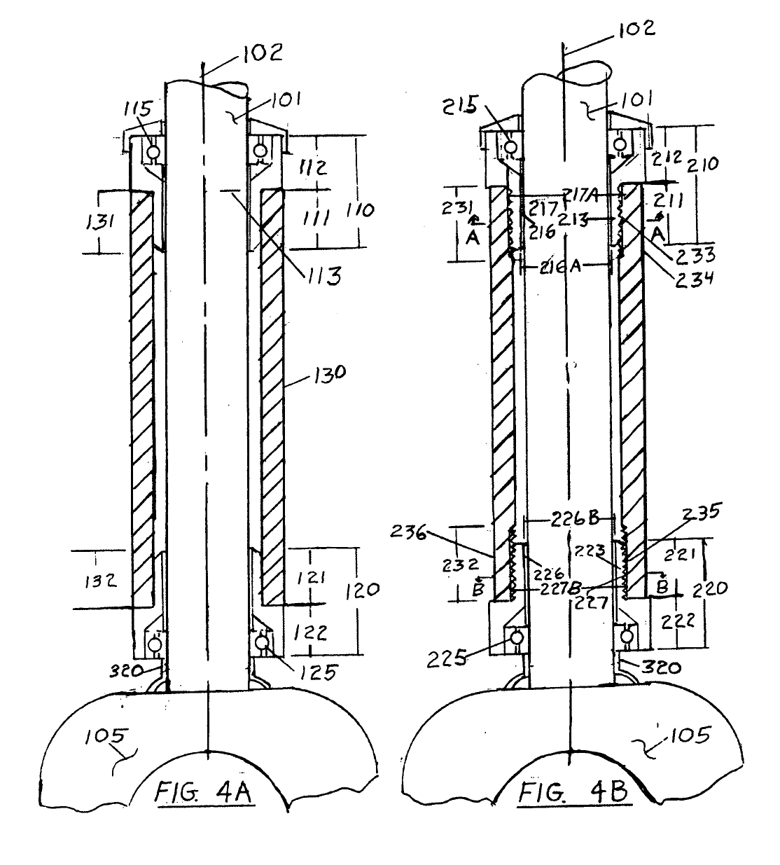

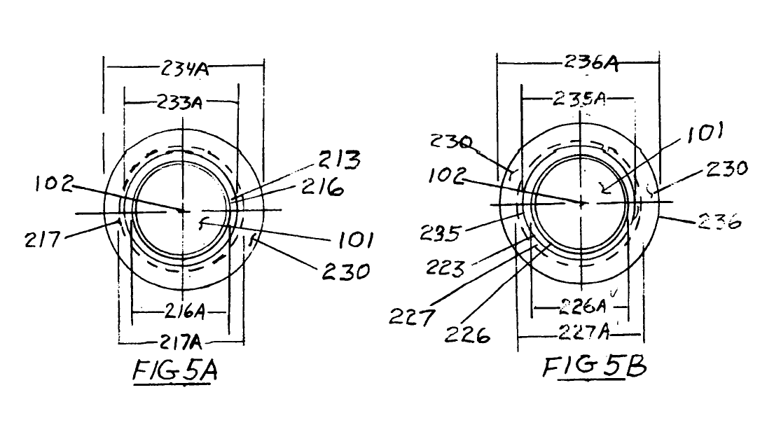

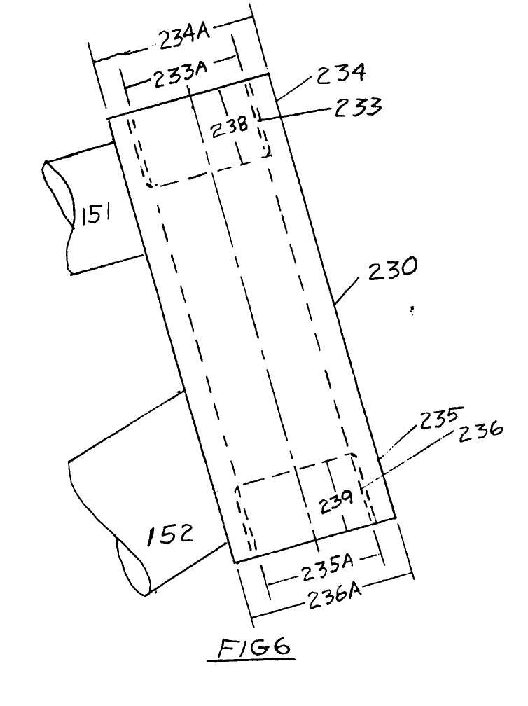

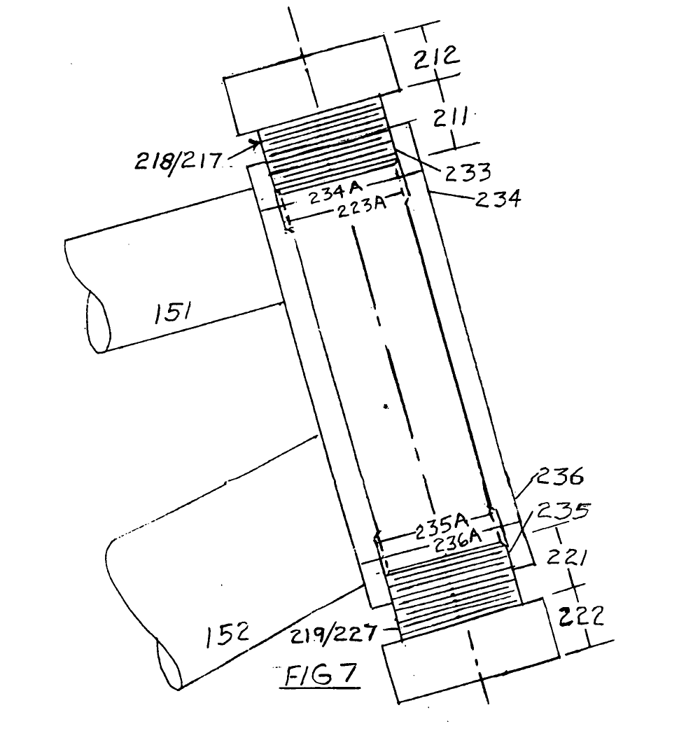

A first embodiment of the current invention as illustrated in FIG. 3, FIG. 4B, FIG. 5A, FIG. 5B, FIG. 6 and FIG. 7 is a bicycle steering assembly comprising a steerer member (101) which defines an axis (102). In this embodiment a headset top cup (210) is positioned on the steerer member axis (102). The headset top cup (210) comprises two portions, namely a top portion (212) and a bottom portion (211). The top portion (212) has a hollow center and contains a bearing (215) positioned radially to the hollow center. The steerer member (201) is positioned inside the hollow center of the top portion (212) of the headset top cup (210). The bottom portion (211) of the headset top cup (210) comprises a top cup tube (213). The top cup (210) is positioned on the same axis (102) as that of the steerer member (101). The top cup tube (213) has two faces, namely an inner face (216) and an outer face (217). The inner face (217) of the top cup tube (213) defines an inner diameter (216a) and the outer face (217) of the top cup tube (213) defines an outer diameter (217a). The inner diameter (216a) of the top cup tube (213) is smaller than the top cup tube's (213) outer diameter (217a). The outer face (217) of the top cup tube (213) is further characterized in that it is threaded with male threads, defining a respective threaded area (218). The threaded area (218) of the top cup tube (213) may extend the entire length of the top cup tube (213) or the threads may only cover a portion of the top cup tube's length. The steerer member (101) is positioned inside of the top cup tube (213). This embodiment of the invention also comprises a head tube (230). The head tube (230) extends along the steerer member axis (102). The head tube (230) has two ends, namely a top end (231) and a bottom end (232). The top end (231) and the bottom end (232) of the head tube (230) each have two faces, an inner face (233 and 235) and an outer face (234 and 236). The inner (233) and outer face (234) of the top end (231) of the head tube (230) each define respective inner (233a) and outer (234a) diameters of the top end (231). The inner (235) and outer (236) face of the bottom end (232) of the head tube (230) each define respective inner (235a) and outer diameters (236a) of the bottom end (232) of the head tube (230). The inner diameters (233a and 235a) of the head tube (230) are smaller than the head tube's (230) outer diameters (234a and 236a). The inner face (233) of the top end (231) of the head tube (230) and the inner face (235) of the bottom end (232) of the head tube (230) are further characterized in that each is threaded with female threads, thereby defining a respective threaded area (238 and 239), as shown in FIG. 6. The threaded areas (238 and 239) of the head tube (230) may extend the entire length of the head tube (230) or there may be a portion of the head tube that is not threaded. The steerer member (101) is positioned inside of the head tube (230). This embodiment of the current invention further comprises a headset bottom cup (22). The headset bottom cup (220) is positioned on the steerer member axis (102) and comprises two portions, namely a top portion (221) and a bottom portion (222). The top portion (222) of the headset bottom cup (220) comprises a bottom cup tube (223) which is positioned on the same axis (102) as that of the steerer member (101). The bottom cup tube (223) has two faces, namely an inner face (226) and an outer face (227). The inner face (226) of the bottom cup tube (223) defines an inner diameter (226b) and the outer face (227) of the bottom cup tube (223) defines an outer diameter (227b). The inner diameter (226b) of the bottom cup tube (223) is smaller than the outer diameter (227b). The outer face (227) of the bottom cup tube (223) is further characterized in that it is threaded with male threads, thereby defining a respective threaded area (219). The threaded area (219) of the bottom cup tube (223) may extend the entire length of the bottom cup tube (223) or the threads may only cover a portion of the bottom cup tube's length. The steerer member (101) is positioned inside of the bottom cup tube (223). The bottom portion (222) of the headset bottom cup (220) has a hollow center and contains a bearing (225) positioned radially to the hollow center. The steerer member (101) is positioned inside the hollow center of the bottom portion (222) of the bottom cup (220). In this embodiment of the invention, at least a portion of the female threaded area (238) of the top end (231) of the head tube (230) is in threaded relationship to at least a portion of the male threaded outer face (217) of the bottom portion (211) of the headset top cup (210). Additionally, at least a portion of the female threaded area (239) of the bottom end (232) of the head tube (230) is in threaded relationship to at least a portion of the male threaded outer face (227) of the top portion (221) of the headset bottom cup (220). In this embodiment of the invention, the steerer member axis (102) extends through the headset top cup top portion (212), the headset top cup bottom portion (211), the head tube top end (231), the head tube bottom end (232), the headset bottom cup top portion (221) and the headset bottom cup bottom portion (222). Differing from prior art such as that described in U.S. Pat. No. 5,979,935 (“Lin”), the steerer member (101) of this embodiment of the current invention is further characterized in that it is capable of being slid through the headset bottom cup (220) while the headset bottom cup top portion (221) is in threaded relationship with the head tube (230). The steerer member (101) of this embodiment of the current invention is also capable of being slid through the headset top cup (210) while the headset top cup bottom portion (211) is in threaded relationship with the head tube (230). It is also noted that the diameter of steerer tube (101) of the invention may be in constant cross section or cross sections of the steerer tube (101) may vary. The steerer member (101) of embodiments of the current invention may also be capable of being slid through the headset top cup (210), the head tube (230), and the headset bottom cup (220) while the headset top cup (210) and the headset bottom cup (220) are in threaded relationship with the head tube (230).

It is important to note that when the present discussion refers to “threaded” headsets, the application is generally referring to the threaded headsets of the current invention having a headset top cup (210) with a male threaded bottom portion (211) and a headset bottom cup (220) with a male threaded top portion (221) each to be threaded into a threaded head tube (230). The threaded headsets of the current invention differ from what the prior art also occasionally refers to as threaded headsets. Unlike the headsets of the current invention, the prior-art threaded headsets were “pressed” into the head tube and secured there with an interference fit. However, the threaded headsets of the prior art were referred to as “threaded” because a portion of the prior-art headset had female threads that received a threaded steerer member. The prior-art threaded headsets were not threaded with respect to the head tube (130).

A second embodiment of the current invention is a method for assembling a bicycle steering assembly on a steerer member (101) attached to the bicycles' front fork (105). This method comprises the step of sliding a fork crown race (320) of a headset bottom cup (220) down a steerer member (101) until it abuts against a fork crown (321) of the bicycle's front fork (105). A threaded top portion (221) of the headset bottom cup (220) is inserted into a threaded bottom end (232) of a head tube (230). The headset bottom cup (220) is rotated until a bottom portion (222) of said headset bottom cup (220) abuts against the head tube (230). Depending on how the headset bottom cup (220) and the head tube (230) are threaded, this rotation may be either clockwise or counter-clockwise. A threaded bottom portion (211) of a headset top cup (210) is inserted into a threaded top end (231) of the head tube (230). The headset top cup (210) is rotated until a top portion (212) of the headset top cup (210) abuts against the head tube (230). Depending on how the headset top cup (210) and the head tube (230) are threaded, this rotation may be either clockwise or counter-clockwise. A bearing (225) is juxtaposed between the bottom portion (222) of the headset bottom cup (220) and the top portion (221) of the headset bottom cup (220). A bearing (215) is juxtaposed between the top portion (212) of the headset top cup (210) and the bottom portion (211) of the headset top cup (210). The method of this embodiment of the current invention further comprises the step of sliding the steerer member (201) through the headset bottom cup (220), followed by sliding the steerer member (201) through the head tube (230), followed by sliding the steerer member (201) through the headset top cup (210). It should be noted in this embodiment as well as other embodiments of the invention, the term “abut” or the term “abuts” includes abutting against spacers, shims, washers, and other similar spacing devices.

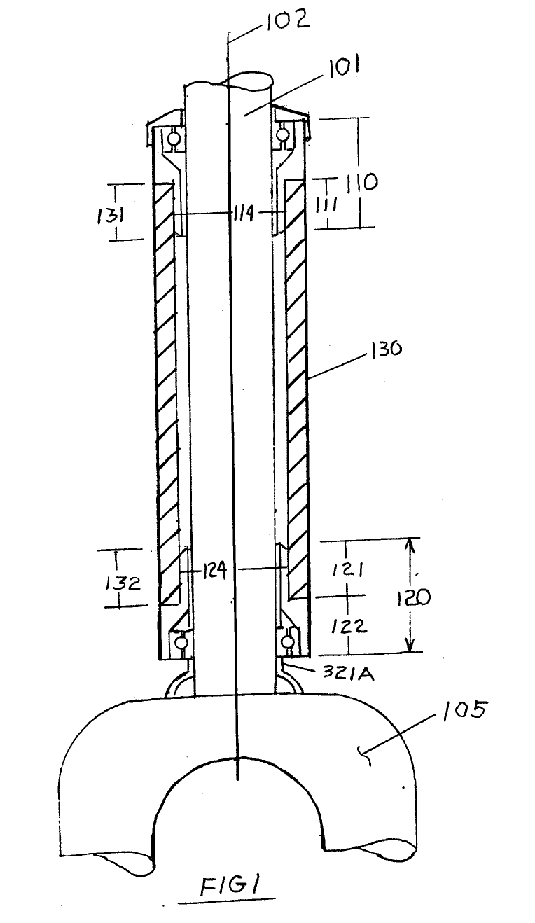

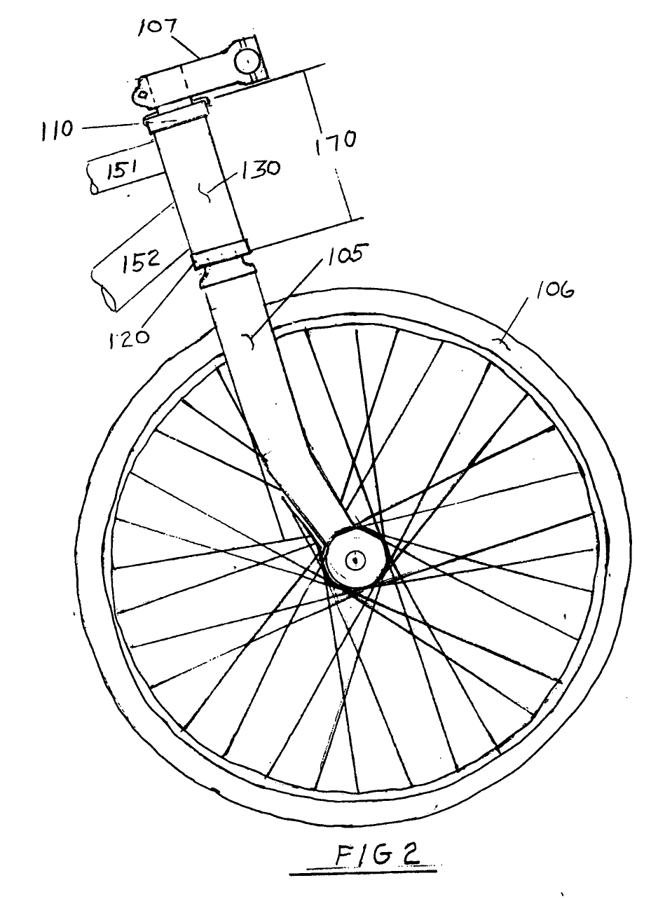

It is possible that the second embodiment of the current invention is desired to be carried out, for example, on a bicycle that currently utilizes interference-fit headset top (110) and bottom (120) cups that are pressed into the head tube (130). Therefore, an additional step would be necessary to “thread” the head tube (130) prior to replacing the interference-fit headsets with the threaded headsets of the current invention. Similarly, if someone desiring to practice the current invention should only have a set of replacement headsets that are non-threaded interference-fit headsets, those headsets would need to be modified by threading them prior to performing the steps of the second embodiment of the current invention. See FIG. 1 and FIG. 4A for illustrations of the interference-fit headsets.

Thus a third embodiment of the current invention, as illustrated in FIG. 4A and FIG. 4B in combination, is a method for assembling a bicycle steering assembly on a steerer member (101) attached to the bicycle's front fork (105). This embodiment is carried out with respect to a headset bottom cup (120) having two portions, namely a non-threaded top portion (121) and a bottom portion (122), a headset top cup (110) having two portions, namely a top portion (112) and a non-threaded bottom portion (111), and a non-threaded head tube (130) having two ends, namely a top end (131) and a bottom end (132). In this embodiment of the invention, the top end (131) of the non-threaded head tube (131) is threaded with female threads, thereby defining the threaded top end (231) of the head tube (230). The bottom end (132) of the non-threaded head tube (130) is threaded with female threads, thereby defining the threaded bottom end (232) of the head tube (230). The non-threaded top portion (121) of the headset bottom cup (120) is threaded with male threads thereby defining the threaded top portion (221) of the headset bottom cup (220). The non-threaded bottom portion (111) of the headset top cup (110) is threaded with male threads thereby defining the threaded bottom portion (211) of the headset top cup (210). This embodiment further comprises the step of sliding a fork crown race (320) of a headset bottom cup (220) down a steerer member (101) until it abuts against a fork crown (321) of the bicycle's front fork (105). The threaded top portion (221) of the headset bottom cup (220) is inserted into the threaded bottom end (232) of a head tube (230). The headset bottom cup (220) is rotated until the bottom portion (222) of the headset bottom cup (220) abuts against the head tube (230). Depending on how the headset bottom cup (220) and the head tube (230) are threaded, this rotation may be either clockwise or counter-clockwise. A threaded bottom portion (211) of a headset top cup (210) is inserted into a threaded top end (231) of the head tube (230). The headset top cup (210) is rotated until a top portion (212) of the headset top cup (210) abuts against the head tube (230). Depending on how the headset top cup (210) and the head tube (230) are threaded, this rotation may be either clockwise or counter-clockwise. A bearing (225) is juxtaposed between the bottom portion (222) of the headset bottom cup (220) and the top portion (221) of the headset bottom cup (220). A bearing (215) is juxtaposed between the top portion (212) of the headset top cup (210) and the bottom portion (211) of the headset top cup (210). The method of this embodiment of the current invention further comprises the step of sliding the steerer member (101) through the headset bottom cup (220), followed by sliding the steerer member (101) through the head tube (230), followed by sliding the steerer member (101) through the headset top cup (210).

The purpose of the third embodiment of the current invention may be to modify prior-art headsets that are not threaded for assembly into a threaded head tube (230) and prior-art head tubes (130) that are not threaded for receiving the threaded headsets of the current invention. The threading that occurs during this embodiment of the invention would need to be completed before inserting the threaded top portion (221) of a headset bottom cup (220) into a threaded head tube (230), and before inserting the threaded bottom portion (211) of the headset top cup (210) into a threaded head tube (230).

Another embodiment of the invention comprises all of the steps of the third embodiment with the exception of threading the top end (131) of the non-threaded head tube (130) with female threads and threading the bottom end (132) of the non-threaded head tube (130) with female threads. Perhaps the head tube was already threaded prior to practicing the steps of this particular embodiment of the invention. The head tube also may have been originally manufactured with threads. An example of where this embodiment might be used is in a situation where a bicycle shop is trying to clear prior-art headset parts out of its inventory. If a bicycle comes in for repair that has a threaded head tube (230), the stock prior-art headset parts would need to be modified (i.e. threaded) to fit the already threaded head tube (230).

Another embodiment of the invention comprises all of the steps of the third embodiment with the exception of threading the non-threaded top portion (121) of the headset bottom cup (120) with male threads and threading the non-threaded bottom portion (111) of the headset top cup (110) with male threads. Perhaps the headsets were purchased, acquired, or manufactured with threads in the top portion (221) of the headset bottom cup (220) and with threads in the bottom portion (211) of the headset bottom cup (210). An example of when this embodiment might be used is in a situation where a bicycle shop stocks the threaded headsets of the current invention. If a bicycle comes in for repair that does not have a threaded head tube (230), the head tube (130) would need to be modified (i.e. threaded) to fit the threaded headsets of the current invention.

Another embodiment of the current invention is a method for dismantling and assembling a bicycle steering assembly on a steerer member (101) attached to the bicycle's front fork (105). The dismantling portion of the method comprises the step of removing the steerer member (101) from the head tube (230), the headset bottom cup (220), and the headset top cup (210). A threaded top portion (221) of a headset bottom cup (220) is removed from a threaded bottom end (232) of a head tube (230) by rotating the headset bottom cup (220) until the threaded top portion (221) of the headset bottom cup (220) and the threaded bottom end (232) of the head tube (230) are no longer coupled. A threaded bottom portion (211) of a headset top cup (210) is removed from a threaded top end (231) of the head tube (230) by rotating the headset top cup (210) until the threaded bottom portion (211) of the headset top cup (210) and the threaded top end of the head tube (231) are no longer coupled. Steps that would occur either prior to our after the dismantling include sliding a fork crown race (320) of a headset bottom cup (220) down a steerer member (101) until it abuts against a fork crown (321) of the bicycle's front fork (105). A threaded top portion (221) of the headset bottom cup (220) is inserted into a threaded bottom end (232) of a head tube (230). The headset bottom cup (220) is rotated until a bottom portion (222) of the headset bottom cup (220) abuts against the head tube (230). Depending on how the headset bottom cup (220) and the head tube (230) are threaded, this rotation may be either clockwise or counter-clockwise. A threaded bottom portion (211) of a headset top cup (210) is inserted into a threaded top end (231) of the head tube (230). The headset top cup (210) is rotated until a top portion (212) of the headset top cup (210) abuts against the head tube (230). Depending on how the headset top cup (210) and the head tube (230) are threaded, this rotation may be either clockwise or counter-clockwise. A bearing (225) is juxtaposed between the bottom portion (222) of the headset bottom cup (220) and the top portion (221) of the headset bottom cup (220). A bearing (215) is juxtaposed between the top portion (212) of the headset top cup (210) and the bottom portion (211) of the headset top cup (210). The method of this embodiment of the current invention further comprises the step of sliding the steerer member (201) through the headset bottom cup (220), followed by sliding the steerer member (101) through the head tube (230), followed by sliding the steerer member (101) through the headset top cup (210).

Another embodiment of the current invention involving a method for dismantling and assembling a bicycle steering assembly on a steerer member (101) attached to the bicycle's front fork (105) is carried out specifically with respect to a non-threaded head tube (130) having two ends, a top end (131) and a bottom end (132). The dismantling portion of the method comprises the step of removing an interference-fit top portion (121) of a headset bottom cup (120) from the bottom end (132) of the non-threaded head tube (130). An interference-fit bottom portion (111) of a headset top cup (110) is removed from the top end (131) of the non-threaded head tube (130). The dismantling portion of this embodiment of the invention is followed by threading the top portion (131) of the non-threaded head tube (130), thereby defining the threaded top end (231) of the head tube (230), and threading the bottom portion (132) of the non-threaded head tube (130), thereby defining the threaded bottom end (232) of the head tube (230). A fork crown race (320) of a headset bottom cup (220) is slid down a steerer member (101) until it abuts against a fork crown (321) of the bicycle's front fork (105). A threaded top portion (221) of the headset bottom cup (220) is inserted into the threaded bottom end (232) of a head tube (230). The headset bottom cup (220) is rotated until a bottom portion (222) of the headset bottom cup (220) abuts against the head tube (230). Depending on how the headset bottom cup (220) and the head tube (230) are threaded, this rotation may be either clockwise or counter-clockwise. A threaded bottom portion (211) of a headset top cup (210) is inserted into the threaded top end (231) of the head tube (230). The headset top cup (210) is rotated until a top portion of the headset top cup (210) abuts against the head tube (230). Depending on how the headset top cup (210) and the head tube (230) are threaded, this rotation may be either clockwise or counter-clockwise. A bearing (225) is juxtaposed between the bottom portion (222) of the headset bottom cup (220) and the top portion (221) of the headset bottom cup (220). A bearing (215) is juxtaposed between the top portion (212) of the headset top cup (210) and the bottom portion (211) of the headset top cup (210). The method of this embodiment of the current invention further comprises the step of sliding the steerer member (101) through the headset bottom cup (220), followed by sliding the steerer member (101) through the head tube (230), followed by sliding the steerer member (101) through the headset top cup (210). Another embodiment of this particular dismantling and assembling method includes the additional steps of removing the steerer member (101) from the interference-fit headset bottom cup (120), removing the steerer member (101) from the non-threaded head tube (130), and removing the steerer member (101) from the interference-fit headset top cup (110), all prior to the first insertion step. An additional step that may or may not be included in either of the embodiments the invention described in this paragraph is the removal of a fork crown race (321a) of an interference-fit headset bottom cup (120) from a steerer member (101), prior to the first insertion step.

It should be appreciated that in any of the embodiments of this invention where the headset bottom cup (220) is inserted into the head tube (230), the rotation of the headset bottom cup (220) until the bottom portion (222) of the headset bottom cup (220) abuts against the head tube (230) may be either clockwise or counter-clockwise depending on the direction of the threads. The same is true for the rotation of the headset top cup (210) until the top portion (212) of the headset top cup (210) abuts against the head tube (230). It should also be appreciated that in any of the embodiments of the invention where the headset bottom cup (220) is dismantled from the head tube (230), the rotation of the headset bottom cup (220) until its threaded portion (219) and the threaded portion (239) of top end (231) of the head tube (230) are no longer coupled may also be either clockwise or counter clockwise depending on the direction of the threads. The same is true for the rotation of the top cup (210) until its threaded portion (218) is no longer coupled with the threaded portion (238) of the bottom end (232) head tube (230).

Those skilled in the art will have no difficulty devising myriad obvious variations and improvements upon the invention without departing from its teachings, all of which variations and improvements are intended to be encompassed by the claims which follow.

It also should be appreciated, that the apparatus and methods of this invention could be practiced with respect to other vehicles such as motorcycles whose prior art also utilizes similar steering systems comprising headsets pressed into head tubes.

We claim:

1. A bicycle steering assembly comprising:
a steerer member defining an axis;
a headset top cup positioned on the steerer member axis, said headset top cup comprising two portions, namely a top portion and a bottom portion,
said top portion having a hollow center and containing a bearing positioned radially to the hollow center, said steerer member positioned inside the hollow center; and
said bottom portion comprising a top cup tube, said top cup tube being positioned on an axis, the axis of said top cup tube being the same as that of the steerer member, said top cup tube having two faces, namely an inner face and an outer face, the inner face defining an inner diameter and the outer face defining an outer diameter, the inner diameter being smaller than the outer diameter, the outer face of the top cup tube further characterized in that it is threaded with male threads, thereby defining a respective threaded area, said steerer member being positioned inside of said top cup tube;
a head tube, said head tube extending along the steerer member axis, said head tube having two ends, namely a top end and a bottom end, said top end and bottom end each having two faces, an inner face and an outer face, the inner and outer face of the top end defining respective inner and outer diameters of the top end and the inner and outer face of the bottom end defining respective inner and outer diameters of the bottom end, the inner diameters being smaller than the outer diameters, the inner face of the top end of the head tube and the inner face of the bottom end of the head tube each being further characterized in that it is threaded with female threads, thereby defining a respective threaded area, said steerer member being positioned inside of said head tube;
a headset bottom cup positioned on the steerer member axis, said headset bottom cup comprising two portions, namely a top portion and a bottom portion,
said top portion comprising a bottom cup tube, said bottom cup tube being positioned on an axis, the axis of said bottom cup tube being the same as that of the steerer member, said bottom cup tube having two faces, namely an inner face and an outer face, the inner face defining an inner diameter and the outer face defining an outer diameter, the inner diameter being smaller than the outer diameter, the outer face of the bottom cup tube further characterized in that it is threaded with male threads, thereby defining a respective threaded area, said steerer member being positioned inside of said bottom cup tube; and
said bottom portion having a hollow center and containing a bearing positioned radially to the hollow center, said steerer member positioned inside the hollow center;
at least a portion of the female threaded area of the top end of the head tube in threaded relationship to at least a portion of the male threaded outer face of the bottom portion of the headset top cup, and at least a portion of the female threaded area of the bottom end of the head tube in threaded relationship to at least a portion of the male threaded outer face of the top portion of the headset bottom cup;
the steerer member axis extending through the headset top cup top portion, the headset top cup bottom portion, the head tube top end, the head tube bottom end, the headset bottom cup top portion and the headset bottom cup bottom portion; and
the steerer member is further characterized in that it is capable of being slid through the headset bottom cup while the top portion of the headset bottom cup is in threaded relationship with the head tube, and said steerer member is capable of being slid through the headset top cup while the bottom portion of the headset top cup is in threaded relationship with the head tube.

2. A method of assembling a bicycle steering assembly on a steerer member attached to a front fork comprising the steps of:
sliding a fork crown race of a headset bottom cup down a steerer member until it abuts against a fork crown of the front fork;
inserting a threaded top portion of said headset bottom cup into a threaded bottom end of a head tube and rotating said headset bottom cup until a bottom portion of said headset bottom cup abuts against the head tube;
inserting a threaded bottom portion of a headset top cup into a threaded top end of the head tube and rotating said headset top cup until a top portion of the headset top cup abuts against the head tube;
juxtaposing a bearing between the bottom portion of said headset bottom cup and the top portion of the headset bottom cup;
juxtaposing a bearing between the top portion of said headset top cup and the bottom portion of the headset top cup;
sliding the steerer member through the headset bottom cup, followed by sliding the steerer member through the head tube, followed by sliding the steerer member through the headset top cup.

3. The method of claim 2 carried out with respect to a headset bottom cup having two portions, namely a non-threaded top portion and a bottom portion, a headset top cup having two portions, namely a top portion and a non-threaded bottom portion, and a non-threaded head tube having two ends, namely a top end and a bottom end, further comprising the steps of:
threading the top end of the non-threaded head tube with female threads, thereby defining the threaded top end of the head tube, and performed before the first inserting step;
threading the bottom end of the non-threaded head tube with female threads, thereby defining the threaded bottom end of the head tube, and performed before the first inserting step;
threading the non-threaded top portion of the headset bottom cup with male threads thereby defining the threaded top portion of the headset bottom cup, and performed before the first inserting step; and
threading the non-threaded bottom portion of the headset top cup with male threads thereby defining the threaded bottom portion of the headset top cup, and performed before the first inserting step.

4. The method of claim 2 carried out with respect to a non-threaded head tube having two ends, a top end and a bottom end, further comprising the steps of:
threading the top end of the non-threaded head tube with female threads, performed before the first inserting step, thereby defining the threaded top end of the head tube; and
threading the bottom end of the non-threaded head tube with female threads, performed before the first inserting step, thereby defining the threaded bottom end of the head tube.

5. The method of claim 2 carried out with respect to a headset bottom cup having two portions, namely a non-threaded top portion and a bottom portion, a headset top cup having two portions, namely a top portion and a non-threaded bottom portion, and further comprising the steps of:
threading the non-threaded top portion of the headset bottom cup with male threads, performed before the first inserting step, thereby defining the threaded top portion of the headset bottom cup; and
threading the non-threaded bottom portion of the headset top cup with male threads, performed before the first inserting step, thereby defining the threaded bottom portion of the headset top cup.

6. The method of claim 2 further comprising the steps of:
removing the steerer member from the head tube, the headset bottom cup, and the headset top cup;
removing the threaded top portion of said headset bottom cup from the threaded bottom end of the head tube by rotating said headset bottom cup until the threaded top portion of said headset bottom cup and the threaded bottom end of the head tube are no longer coupled;
removing the threaded bottom portion of said headset top cup from the threaded top end of the head tube and rotating said headset top cup until the threaded bottom portion of said headset top cup and the threaded top end of the head tube are no longer coupled.

7. The method of claim 2 carried out with respect to a non-threaded head tube having two ends, a top end and a bottom end, further comprising the steps of:
removing an interference-fit top portion of a headset bottom cup from the bottom end of the non-threaded head tube, prior to the first insertion step;
removing an interference-fit bottom portion of a headset top cup from the top end of the non-threaded head tube, prior to the first insertion step;
threading the top portion of the non-threaded head tube, prior to the first insertion step, thereby defining the threaded top end of the head tube; and
threading the bottom portion of the non-threaded head tube, prior to the first insertion step, thereby defining the threaded bottom end of the head tube.

8. The method of claim 2 carried out with respect to a non-threaded head tube having two ends, a top end and a bottom end, further comprising the steps of:
removing the steerer member from an interference-fit headset bottom cup, prior to the first insertion step;
removing the steerer member from the non-threaded head tube, prior to the first insertion step;
removing the steerer member from an interference-fit headset top cup, prior to the first insertion step;
removing the interference-fit top portion of a headset bottom cup from the bottom end of the non-threaded head tube, prior to the first insertion step;
removing the interference-fit bottom portion of a headset top cup from the top end of the non-threaded head tube, prior to the first insertion step;
threading the top portion of the non-threaded head tube, prior to the first insertion step, thereby defining the threaded top end of the head tube; and
threading the bottom portion of the non-threaded head tube, prior to the first insertion step, thereby defining the threaded bottom end of the head tube.

9. The method of claim 2 further characterized in that the headset bottom cup is rotated in a clockwise direction until the bottom portion of the headset bottom cup abuts against the head tube.

10. The method of claim 2 further characterized in that the headset top cup is rotated in a clockwise direction until the top portion of the headset top cup abuts against the head tube.

11. The method of claim 6 further characterized in that the headset bottom cup is rotated in a counter-clockwise direction until the threaded top portion of said headset bottom cup and the threaded bottom end of the head tube are no longer coupled.

12. The method of claim 6 further characterized in that the headset top cup is rotated in a counter-clockwise direction until the threaded bottom portion of said headset top cup and the threaded top end of the head tube are no longer coupled.

13. The method of claim 7 further comprising the step of:
removing a fork crown race of an interference-fit headset bottom cup from a steerer member, prior to the first insertion step.

14. The method of claim 8 further comprising the step of:
removing a fork crown race of an interference-fit headset bottom cup from a steerer member, prior to the first insertion step.

15. A method for dismantling a bicycle steering assembly on a steerer member attached to a front fork comprising the steps of:
removing the steerer member from a head tube, said head tube having two ends, namely a top end and a bottom end, said top end and bottom end each having two faces, an inner face and an outer face, the inner and outer face of the top end defining respective inner and outer diameters of the top end and the inner and outer face of the bottom end defining respective inner and outer diameters of the bottom end, the inner diameters being smaller than the outer diameters, the inner face of the top end of the head tube and the inner face of the bottom end of the head tube each being further characterized in that it is threaded with female threads, thereby defining a respective threaded area;
removing the steerer member from a first headset bottom cup, said first headset bottom cup comprising two portions, namely a top portion and a bottom portion, said top portion comprising a bottom cup tube, said bottom cup tube having two faces, namely an inner face and an outer face, the inner face defining an inner diameter and the outer face defining an outer diameter, the inner diameter being smaller than the outer diameter, the outer face of the bottom cup tube further characterized in that it is threaded with male threads, thereby defining a respective threaded area;
removing the steerer member from a first headset top cup, said first headset top cup comprising two portions, namely a top portion and a bottom portion, said bottom portion comprising a top cup tube, said top cup tube having two faces, namely an inner face and an outer face, the inner face defining an inner diameter and the outer face defining an outer diameter, the inner diameter being smaller than the outer diameter, the outer face of the top cup tube further characterized in that it is threaded with male threads, thereby defining a respective threaded area;
removing the threaded top portion of said first headset bottom cup from the threaded bottom end of the head tube by rotating said first headset bottom cup until the threaded top portion of said first headset bottom cup and the threaded bottom end of the head tube are no longer coupled;
removing the threaded bottom portion of said first headset top cup from the threaded top end of the head tube and rotating said first headset top cup until the threaded bottom portion of said headset top cup and the threaded top end of the head tube are no longer coupled.

16. The method of claim 15 further comprising the steps of:
sliding a fork crown race of a second headset bottom cup down the steerer member until it abuts against a fork crown of the front fork;
inserting a threaded top portion of said second headset bottom cup into the threaded bottom end of the head tube and rotating said second headset bottom cup until a bottom portion of said second headset bottom cup abuts against the head tube;
inserting a threaded bottom portion of a second headset top cup into a threaded top end of the head tube and rotating said second headset top cup until a top portion of the second headset top cup abuts against the head tube;
juxtaposing a bearing between the bottom portion of said second headset bottom cup and the top portion of the second headset bottom cup;
juxtaposing a bearing between the top portion of said second headset top cup and the bottom portion of the second headset top cup;
sliding the steerer member through the second headset bottom cup, followed by sliding the steerer member through the head tube, followed by sliding the steerer member through the second headset top cup.

17. A method for modifying a headset bottom cup and a headset top cup, carried out with respect to a headset bottom cup having two portions, namely a non-threaded top portion and a bottom portion, a headset top cup having two portions, namely a top portion and a non-threaded bottom portion, comprising the steps of:
cutting male threads onto the non-threaded top portion of the headset bottom cup thereby defining a threaded top portion of a headset bottom cup; and
cutting male threads onto the non-threaded bottom portion of the headset top cup thereby defining a threaded bottom portion of a headset top cup.
